(19) United States
(12) Patent Application Publication
(10) Pub. No.: US 2018/0209918 A1
(43) Pub. Date: Jul. 26, 2018

(54) OPTICAL INSPECTION SYSTEM FOR TRANSPARENT MATERIAL

(71) Applicant: SYNERGX TECHNOLOGIES INC., Laval (CA)

(72) Inventor: Vincenzo Tarantino, Laval (CA)

(73) Assignee: SYNERGX TECHNOLOGIES INC., Laval, QC (CA)

(21) Appl. No.: 15/744,497

(22) PCT Filed: Jul. 12, 2016
(86) PCT No.: PCT/CA2016/050821

§ 371 Date: Jan. 12, 2018

Related U.S. Application Data
(60) Provisional application No. 62/192,129, filed on Jul. 14, 2015.

(51) Int. Cl. G01N 21/958; G01N 21/896; G01N 21/88

(52) U.S. Cl. CPC G01N 21/958; G01N 21/896; G01N 2021/9586; G01N 21/8851; G01N 21/8806

(57) ABSTRACT

A system and a method for inspecting a transparent object. The system may comprise a light source module; a collimating lens system; a sensor; a collector lens system for concentrating the sheet of light, passed through the object, in a plane of the sensor; and an optical element, the optical element being adapted to provide different focus ranges for the light portions emitted with different colors (intensity peak wavelengths).

This application claims the benefit of U.S. provisional patent application No. 62/192,129, filed Jul. 14, 2015, which is incorporated herein in its entirety by reference.

### FIELD

The present subject-matter relates to inspecting transparent material and to detecting, identification and sizing defects in curved or flat transparent articles such as automotive glass objects.

### INTRODUCTION

An object made of transparent material may have scratches and defects that cannot be readily detected by the human eye. An automatic, rapid system is therefore often used to inspect large quantities of transparent articles, such as windshields and other automotive glass.

Known systems for glass inspection, which involve scanning imaging of glass sheets, are limited by the image resolution required to detect the defects in the glass and by the depth of field (or focus range) of the system. In particular, the larger the required resolution, the narrower is the depth of field that the inspection system may have. This limits the size, and in particular, the thickness of the object that may be inspected and for which a full image may be rapidly obtained. For example, when the required resolution of the system is 100 microns, the depth of field may be maximum of 50 mm. Therefore, the thickness, or a smallest dimension of the transparent object under inspection is limited to 50 mm.

It may be desirable, however, to be able to rapidly inspect transparent objects with dimensions larger than 50 mm. For example, in the automotive industry, a windshield may have a curvature depth as large as 200 mm. None of known inspection systems are currently adapted to rapidly inspect such transparent objects.

### SUMMARY

The following summary is intended to introduce the reader to the more detailed description that follows, and not to define or limit the claimed subject matter.

In a first aspect, in at least one example embodiment described herein, there is provided a system for inspecting a transparent object. In at least one embodiment, the system may have a plurality of focus ranges. The system may comprise a light source module adapted to emit light with a first intensity peak at a first peak wavelength and to emit light with a second intensity peak at a second peak wavelength; a collimating lens system adapted to transform the emitted light into a collimated sheet of light; a sensor; a collector lens system for concentrating the sheet of light, passed through the transparent object, in a plane of the sensor; and an optical element located between the collector lens system and the sensor. The optical element may be adapted to provide a first focus range for the light emitted with the first intensity peak at the first peak wavelength and a second focus range for the light emitted with the second intensity peak at the second peak wavelength, wherein at least a portion of the first focus range is located outside of the second focus range.

In at least one embodiment, the first focus range and the second focus range may be adjacent to each other, so as to define an extended focus range of the system. In at least one embodiment, the first focus range and the second focus range are overlapping.

In at least one embodiment, the light source module may comprise at least one first light source adapted to emit light with the first intensity peak at the first peak wavelength and at least one second light source adapted to emit light with the second intensity peak at the second peak wavelength.

In at least one embodiment, the first light source and the second light source are adapted to emit light alternatingly.

In at least one embodiment, the sensor is adapted to capture at least one first image when the peak intensity of the emitted light is at the first wavelength; and at least one second image when the peak intensity of the emitted light is at the second wavelength.

In at least one embodiment, the optical element comprises a first lens and a second lens. In at least one embodiment, the optical element may comprise a plano-concave first lens and a plano-convex second lens. In at least one embodiment, the optical element may be a doublet. In at least one embodiment, the optical element may be stationary.

In at least one embodiment, the light source module may comprise at least two light emitting diodes. In at least one embodiment, the light source module may comprise an array of light emitting diodes.

In at least one embodiment, each focus range may be about 60 mm.

In at least one embodiment, the light source module may be adapted to emit light with a third intensity peak at a third peak wavelength. In at least one embodiment, the light source module may be adapted to emit light with a fourth intensity peak at a forth peak wavelength.

In at least one embodiment, the transparent object may be a glass. In at least one embodiment, the transparent object may be a sheet of glass. In at least one embodiment, the transparent object may be a curved sheet of glass.

In a second aspect, in at least one example embodiment described herein, there is provided a method of inspecting a transparent object. The method may comprise emitting a first portion of light having a first intensity peak at a first peak wavelength; transmitting the first portion of light through at least one portion of the transparent object; transmitting the first portion of light through an optical element, the optical element being adapted to provide a first focus range for the first portion of light; capturing a first image of the at least one portion of the transparent object by a sensor, the first image being focused at the first focus range being located at a first focal length from the sensor; emitting a second portion of light having a second intensity peak at a second peak wavelength; transmitting the second portion of light through the at least one portion of the transparent object; transmitting the second portion of light through the optical element, the optical element being adapted to provide a second focus range for the second portion of light, the second focus range being located at a different distance from the sensor compared to the first focus range; capturing a second image of the at least one portion of the transparent object; combining the first image and the second image for the at least one portion of the transparent object to generate an interlaced image of the transparent object; and generating a composite image of the transparent object.

In at least one embodiment, generating the composite image of the transparent object further may comprise de-interlacing the interlaced image to generate a first de-interlaced image and a second de-interlaced image; normalizing the first de-interlaced image and the second de-interlaced image to generate a first normalized image and a second normalized image; for each normalized image, generating a first second local edge strength and a second local edge strength image from the normalized images; weighting the first and second local edge strength images; and combining the weighted first and second local edge strength images.

In at least one embodiment, the transparent object may be a glass. In at least one embodiment, the transparent object may be a sheet of glass. In at least one embodiment, the transparent object may be a curved sheet of glass.

In a third aspect, in at least one example embodiment described herein, there is provided a method of inspecting a transparent object. In at least one embodiment, the method may comprise emitting at least two portions of light with different intensity peak wavelengths; transmitting the at least two portions of light alternatingly through at least one portion of the transparent object; transmitting the at least two portions of light through an optical element, the optical element adapted to provide at least two focus ranges, each focus range corresponding to one peak wavelength; capturing at least two images of the at least one portion of the transparent object by a sensor, each image being focused at a focus range and each focus range being located at a different focal length from the sensor; combining the at least two images for the at least one portion of the transparent object to generate an interlaced image of the transparent object; and generating a composite image of the transparent object.

In at least one embodiment, generating the composite image of the transparent object may further comprise de-interlacing the interlaced image to generate at least two de-interlaced images, the number of de-interlaced images being equal to the number of portions of emitted light; normalizing each of the at least two de-interlaced images to generate at least one normalized image; for each normalized image, generating at least two local edge strength images from the at least two normalized images; weighting each of the at least two local edge strength images; and combining the weighted at least two local edge strength images to generate the composite image of the transparent object.

In at least one embodiment, the number of portions of light emitted may be four. In at least one embodiment, the transparent object may be a glass. In at least one embodiment, the transparent object may be a sheet of glass. In at least one embodiment, the transparent object may be a curved sheet of glass.

### DRAWINGS

For a better understanding of the subject matter herein and to show more clearly how it may be carried into effect, reference will now be made, by way of example, to the accompanying drawings which show at least one exemplary embodiment, and in which:

FIG. 1 illustrates a side view of a system for inspecting a transparent object, in accordance with at least one embodiment;

FIG. 2 illustrates an example implementation of a light source module using an array of light sources, in accordance with at least one embodiment;

FIG. 3 illustrates an example implementation of a light source module using a dichroic beam splitter, in accordance with at least one embodiment;

FIG. 4 illustrates a schematic side view of an optical element, in accordance with at least one embodiment;

FIG. 5A illustrates a schematic representation of the spectra emitted by a light source module, in accordance with at least one embodiment;

FIG. 5B illustrates a schematic graphical interpretation of the time dependence of the intensity of each light portion emitted by a light source module, in accordance with at least one embodiment;

FIG. 6 illustrates a schematic view of a portion of an interlaced image, in accordance with at least one embodiment;

FIG. 7 illustrates a schematic view of an inspection method, in accordance with at least one embodiment;

FIG. 8 illustrates a portion of the method of inspecting a transparent object, in accordance with at least one embodiment;

FIG. 9 illustrates a schematic view of a method for reconstructing an image, in accordance with at least one embodiment;

FIG. 10A illustrates a schematic planar view of a system for inspecting the transparent object, in accordance with at least one embodiment;

FIG. 10B illustrates a schematic side view of a composite system for inspecting the transparent object, in accordance with at least one embodiment;

FIG. 11 illustrates a schematic view of a method of inspection of the transparent object, in accordance with at least one embodiment;

FIG. 12 illustrates a schematic view of a method for reconstructing an image of the transparent object, in accordance with at least one embodiment.

### DESCRIPTION OF VARIOUS EMBODIMENTS

It will be appreciated that, for simplicity and clarity of illustration, where considered appropriate, reference numerals may be repeated among the figures to indicate corresponding or analogous elements or steps. Numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the present subject matter. Furthermore, this description is not to be considered as limiting the scope of the subject matter described herein in any way but rather as merely describing the implementation of the various embodiments described herein.

A known system for detecting defects in a piece of glass has a light source, a collimating lens system, a telecentric imaging lens system, and a camera. During inspection, a windshield or other sheet of automotive glass (or an article made of another transparent material) may be positioned between the collimating lens system and the telecentric imaging lens system, where the light rays are parallel.

In such a system, an objective lens may be provided in front of the camera so that its focal point falls between the collimating lens system and the telecentric lens system and is aligned with the sheet of glass. A line of light from the light source may scan the length of the glass under inspection. The camera may capture multiple images of the light passing through the glass during the scanning along the axis of the longest dimension of the glass, thereby capturing a full image of the glass.

A person skilled in the art would appreciate that the resolution requirements establish the limit for the depth of field of the abovementioned inspection system. Indeed, a depth of field (DOF), or a focus range, of an imaging system is limited by the system numerical aperture (NA). A large NA may provide better optical resolution but at the same time may decrease the system's DOF. On the other hand, a small NA impacts the system diffraction limit thus reducing the resolution. Therefore, there is a maximum DOF one can obtain for a required resolution.

For the resolution of 100 micron, the known system typically provides a depth of field of 50 mm. The light emitted by the source and which hits defects in the glass within the 50 mm depth of field, may be captured by the camera.

It is desirable to increase the DOF of the system when an article to be inspected has a curvature or has a narrowest dimension that is wider than the DOF of the inspecting system. For example, the depth of the curvature or the narrowest dimension of the glass object may be larger than the DOF (or the focus range) of the system.

In such cases, according to at least one embodiment described herein, a larger DOF may be achieved by focus stacking; multiple images may thus be taken at different focal lengths.

To capture images at different focal lengths, an optical element may be designed to create a controlled amount of chromatic aberration. Chromatic aberration is the phenomenon where light beams of different wavelengths passing through a lens have slightly different focal lengths. Chromatic aberration is a direct consequence of the fact that the refraction index n varies with wavelength. According to at least one embodiment, by combining the optical element with a commercial grade objective lens, one can achieve stacked focus ranges which are dependent on the wavelength.

By modulating the wavelength of the illuminating light, multiple images at various focal lengths may be obtained. These multiple images may then be processed to construct a composite image which may be in focus throughout the required field of view.

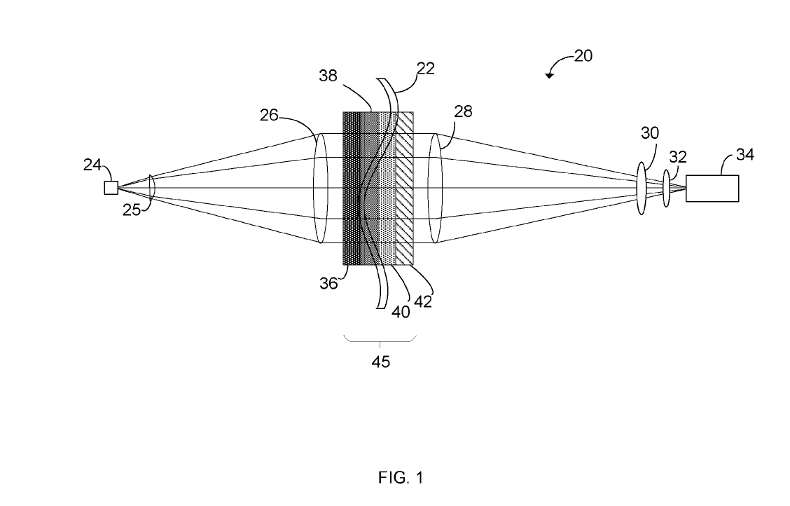

Referring to FIG. 1, illustrated therein is a system 20 for inspecting an object of transparent material 22, in accordance with at least one embodiment. The transparent object 22 may be inspected using the system 20.

The transparent object 22 may be a sheet of glass. For example, the transparent object 22 may be a curved automotive windshield. It should be understood, however, that the system 20 may be adapted to inspect other articles made from the transparent material. For example, the system 20 may be used for inspecting articles made of transparent plastics (such as, for example, plexiglass, polycarbonate), polyvinyl chloride (pvc) or a combination of such materials.

The system 20 may comprise a light source module 24, a collimating lens system 26, a collector lens system 28, an optical element 20, and a sensor 34.

According to at least one embodiment, the light source module 24 may be adapted to emit light. For example, the intensity spectrum of the emitted light may have an intensity peak at one certain wavelength. The light may be emitted within a certain wavelength range. The light may be emitted such that within a certain wavelength range the intensity is higher than a certain intensity threshold.

In at least one embodiment, the light source module 24 may be adapted to emit two or more portions of light.

The light source module 24 may be implemented using any light source adapted to emit light with the intensity peak at a first wavelength during the first time interval, and with the intensity peak at a second wavelength during the second time interval. The light source module 24 may be implemented using any light source adapted to emit light with the intensity peaks at various wavelengths. For example, at each particular moment, and for a certain time interval, the emitted spectrum may have only one intensity peak at one particular wavelength.

The light source module 24 may comprise one or more light sources. For example, one, or more than one, of the light sources of the light source module 24 may emit one portion of light at a time. The light source module 24 may comprise one or more light sources that may emit light with the intensity peak at a first wavelength λ₁; one or more light sources that may emit light with the intensity peak at a second wavelength λ₂; one or more light sources that may emit light with the intensity peak at a third wavelength λ₃; or one or more light sources that may emit light with the intensity peak at a fourth wavelength λ₄.

For example, the light source module 24 may be a multi spectral light source module. The multi spectral light source may provide at least two portions of light, each portion having intensity peaks at different wavelengths (for example, λ₁, λ₂, etc.).

According to at least one embodiment, the light source module 24 may be implemented using at least one light emitting diode (LED). For example, the at least one LED may have output power of about 3 watts. For example, the at least one LED may have a spectral bandwidth of about 25 nm or less. For example, the at least one LED may be turned on and off within several microseconds.

According to at least one embodiment, the light source module 24 may be implemented using an array of light sources.

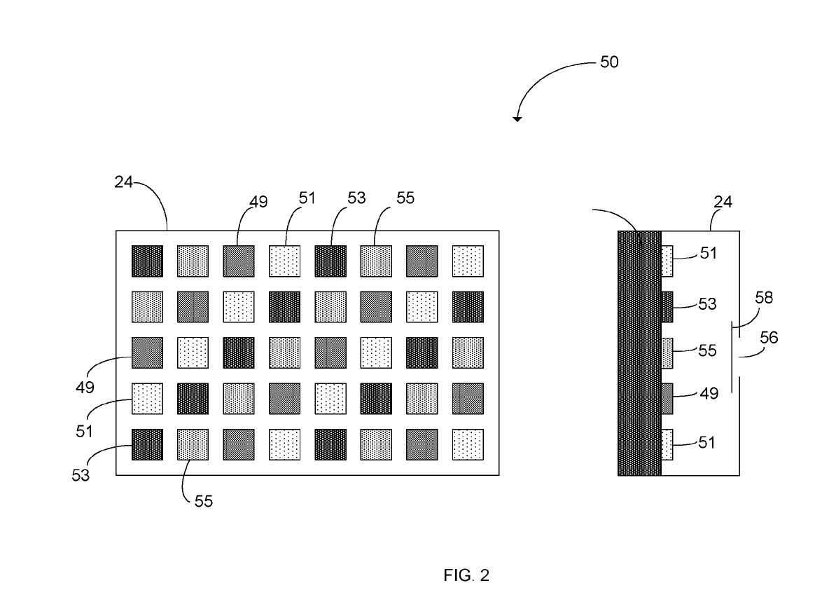

Referring now to FIG. 2, shown therein is an example implementation of the light source module 24 using an array 50 of light sources, in accordance with at least one embodiment. For example, the light source module 24 may comprise an array 50 of light sources, an aperture 56 and a diffuser 58. The array 50 of light sources may be an array of light emitting diodes (LEDs). For example, the array 50 may be a printed circuit board (PCB) array of LEDs. The LED PCB array 50 may be designed such that it may dissipate the heat from the LEDs.

Referring still to FIG. 2, the array may comprise at least one first light source 49, which may emit light with peak intensity at the first wavelength λ₁ and at least one second light source 51 which may emit light with peak intensity at the second wavelength λ₂.

The light source module 24 may also comprise at least one third light source 53 which may emit light with peak intensity at the third wavelength λ₃. According to at least one embodiment, the light source module 24 may also comprise at least one fourth light source 55 which may emit light with peak intensity at the fourth wavelength λ₄.

In each row, the first light source 49 may be followed by a second light source 51, then followed by the third light source 53, and then followed by the fourth light source 55. The light sources 49, 51, 53, 55 in the array 50 may be organized in 4 groups of 10. Each of the groups may have a particular emitting spectrum with the peak intensity at a particular wavelength providing a light source module 24 with 4 independent wavelengths. An aperture with a diffuser for spatial de-coherence will create a pseudo point source of light whose dimension is defined by the aperture size.

According to at least one embodiment, the diffuser 58 may be installed in the light source module 24 in order to evenly distribute light from the array 50 of light sources and eliminate bright spots. The diffuser 58 can be any optical component that may ensure that the radiance may be independent or almost independent of angle. For example, the diffuser 58 may be a holographic diffuser. An aperture and an angle of diffusion of the diffuser 58 may depend on geometry of the system. For example, the aperture may be about 15 mm and an angle of diffusion may be of 45×75 degree.

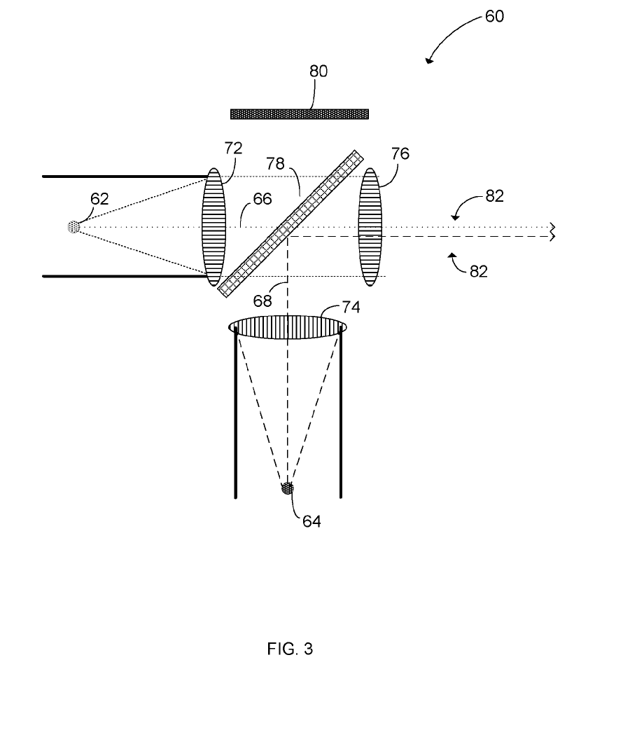

Referring now to FIG. 3, shown therein is one example implementation of a light source module 24 using a dichroic beam splitter (DBS) 60, in accordance with at least one embodiment. The dichroic beam splitter 60 may comprise at least two DBS light sources. For example, the dichroic beam splitter 60 may comprise a first DBS light source 62 and a second DBS light source 64. The first and the second DBS light sources 62 and 64 may be LEDs, and may be independently illuminated.

The first DBS source 62 may emit light with an intensity having a peak at a first DBS wavelength and the second DBS source 64 may emit light with an intensity having a peak at a second DBS wavelength. The first and the second DBS sources 62 and 64 may operate at the same time, or the first and the second DBS sources 62 and 64 may operate alternatingly.

According to at least one embodiment, the dichroic beam splitter 60 may comprise a DBS collimator optics system and a dichroic mirror 78. The DBS collimator optics system may comprise at least two collimating lenses.

The DBS collimator optics system may comprise a first DBS collimating lens 72 and a second DBS collimating lens 74, as shown at FIG. 3. For example, the first DBS collimating lens 72 may be installed such that it may collimate the light emitted by the first DBS source 62 into a collimated light beam 66. For example, the second DBS collimating lens 74 may be installed such that it may collimate the light emitted by the second DBS source 64 into a collimated light beam 68.

It should be understood that collimation of the light beams may alternatively be implemented using more than two lenses.

According to at least one embodiment, a dichroic mirror 78 may be adapted to reflect light of one wavelength interval while passing the light of another wavelength interval. For example, the dichroic mirror 78 may pass the light emitted from the first DBS source 62 and may reflect the light emitted from the second DBS source 64. For example, the dichroic mirror 78 may reflect the beam 68 and transmit the beam 66 as shown at FIG. 3. The transmitted beam 82 may be a combination of two light portions with two different peak wavelengths. Alternatively, where the first and the second DBS light sources 62 and 64 operate alternatingly, the beam 82 may have a peak wavelength of the light source operating at the moment.

According to at least one embodiment, the dichroic beam splitter 60 may permit two DBS sources 62 and 64 to emit light in the same direction, the two beams being coaxial. At the output port of the light source module 24, a virtual image of the two DBS sources 62 and 64 may be coaxially combined resulting in a virtual point source of light made of two independent wavelengths.

According to at least one embodiment, each of the portions of light emitted by the light source module 24 may be independently turned on with a strobe device during a certain time interval. For example, the portions of light may be turned on about every 25 microseconds for duration of time between about 12 and 24 microseconds.

In at least one embodiment, the system 20 may further comprise a condenser lens 25 to concentrate light from the source 24 into a cone of light that illuminates the collimating lens system 26.

The collimating lens system 26 may collimate the light which illuminates the object 22. The collimating lens system 26 may comprise a condenser lens and a spherical biconvex lens. The collector lens system 28 may collect the light passed through the object 22. The collector lens system 28 may comprise a spherical biconvex lens.

According to at least one embodiment, the collimating lens system 26 and the collector lens system 28 may form an inspection sandwich. Such telecentric imaging optics design can provide parallel light rays and constant magnification within the inspection sandwich. A telecentric imaging optics design can also result in high contrast silhouette images. Thus, an interior defect or a particle or a scratch on a surface of the transparent object 22 may show as a dark contrast within the image.

According to at least one embodiment, the system 20 may further comprise an objective lens 32 and a sensor 34.

The sensor 34 may be implemented using a camera, such as a line scan camera. The line scan camera may produce one line of data for each of the light strobe events. Since the light source module 24 may cycle through its N different light portions, corresponding to N different intensity peak wavelengths, in a sequential manner, the output image captured by the line scan camera may consist of interlaced lines. For example, each line may originate from a given wavelength.

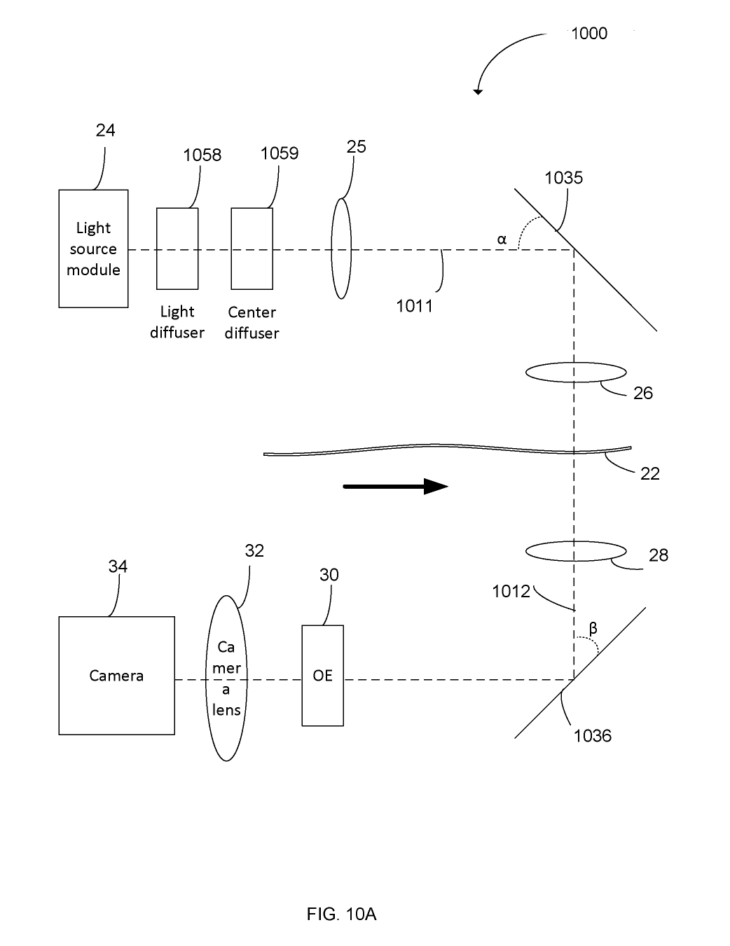

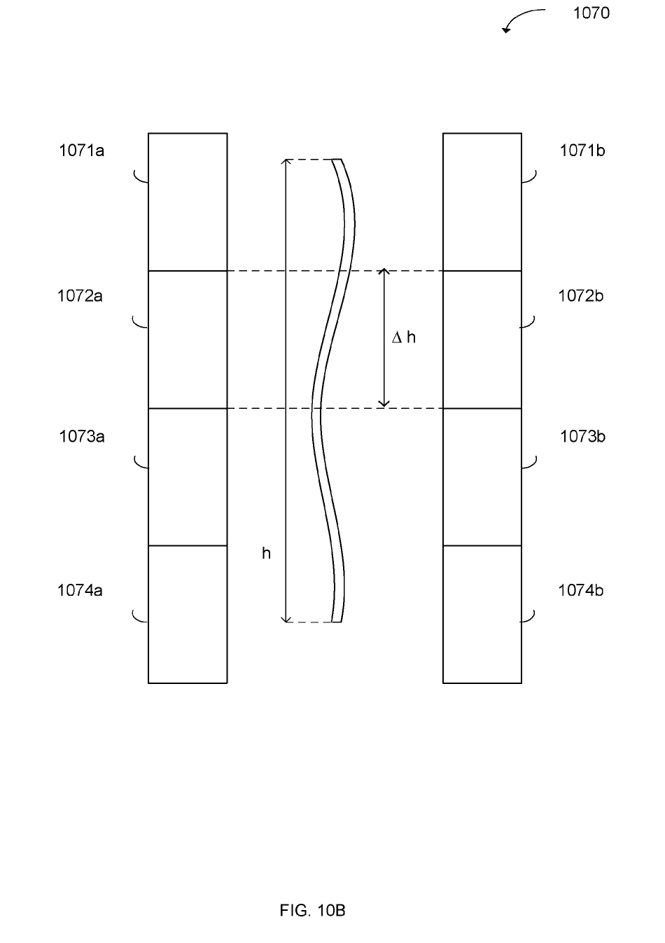

FIG. 10A shows a planar view of the system 1000 for inspecting a transparent object 22, in accordance with at least one embodiment. For example, a mirror 1035 and a mirror 1036 may help to make the inspecting system more compact. For example, the mirror 1035 may be positioned at an angle α to the light beam 1011, transmitted through the condenser lens 25, and the mirror 1036 may be positioned at an angle β to the light beam 1012, transmitted through the collector lens system 28. For example, the angles α and β may be about 45°. The angles α and β may be between about 40° and 50°.

The transparent object 22 may move relative to the inspection system as shown at FIG. 10A. Therefore, the width of the portion of the transparent object 22 that is captured during the exposure to the first portion of light may be determined by the time of the first portion of light being emitted by the light source module 24 and moving speed of the transparent object 22 relative to the inspecting system.

For example, if the transparent object 22 moves in between the collimating lens system 26 and the condenser lens 25, as shown at FIG. 10A, with a speed of about 60 meters per minute, a total of 100 microseconds may be available to trigger all portions of light in order to achieve a resolution of 100 microns of the inspection system. For example, if the system has four different portions of light emitted by the light source module 24, there may be 100 microns available to inspect each portion of the transparent object 22 and therefore only about 25 microseconds to expose each portion of the transparent object 22 to each portion of light. Therefore, in this example, one portion of light emitted by the light source 24 may be turned on every 25 microseconds. The duration of the light portion being emitted from the light source 24 may be between 12 and 24 microseconds and may depend, for example, on particular wavelength of the light portion.

The person skilled in the art would understand that inspected height of transparent object 22 may be limited not only by characteristics of the light source module 24, but also by geometry of various elements of the systems 20 or 1000, such as, for example, a dimension of condenser lens 25 or a dimension of collimating lens system 26.

In at least one embodiment, two or more systems 20 or 1000 may be stacked one over another in order to inspect transparent objects 22 which are higher than an inspection height Δh provided by the systems 20 or 1000.

FIG. 10B shows a schematic side view of a composite system 1070 for inspecting the transparent object 22, in accordance with at least one embodiment. For example, each of subsystems 1071a, 1072a, 1073a, and 1074a of the composite system 1070 may comprise a source 24, a condenser lens 25, and a collimating lens system 26. Each of subsystems 1071a, 1072a, 1073a, and 1074a of the composite system 1070 may further comprise a light diffuser 1058, a center diffuser 1059, and a mirror 1035. Each of subsystems 1071b, 1072b, 1073b, and 1074b of the composite system 1070 may comprise a collector lens system 28, an OE 30, an objective lens 32, and a sensor 34. Each of subsystems 1071b, 1072b, 1073b, and 1074b of the composite system 1070 may further comprise a mirror 1036. For example, the subsystems 1071a and 1071b may form one inspection system 1071. For example, the subsystems 1072a and 1072b may form one inspection system 1072. For example, the subsystems 1073a and 1073b may form one inspection system 1073. For example, the subsystems 1074a and 1074b may form one inspection system 1074. As shown at FIG. 10B, the inspection systems 1071, 1072, 1073, and 1074 may be stacked one over another to form one composite system 1070 for inspecting the transparent object 22 of height h.

For example, one inspection system 1071 may have an inspection height Δh of about 400 mm to inspect a transparent object 22 of height of about 400 mm. For example, the inspection systems 1071, 1072, 1073, and 1074 may be stacked one over another to inspect a transparent object 22 which is higher than 400 mm. For example, four inspection systems 1071, 1072, 1073, and 1074 stacked one over another may provide the inspection height of about 1600 mm.

According to at least one embodiment, an optical element (OE) 30 may be designed to create a controlled amount of chromatic aberration in order to achieve stacked depths of field for the different peak wavelengths, thus forming an extended focus range 45. According to at least one embodiment, by combining the OE 30 with an objective lens 32, a variable focal length lens may be designed, such that the focal length may become dependent on the wavelength emitted by the light source module 24.

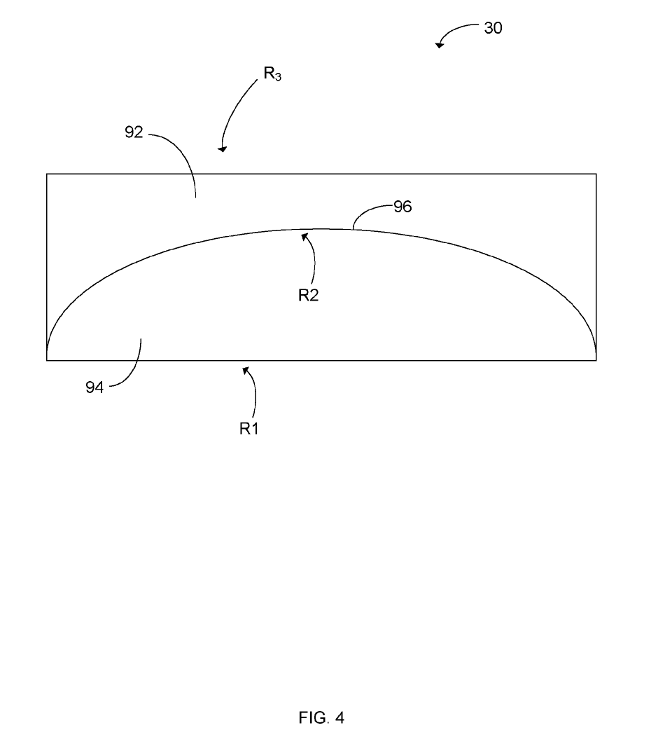

FIG. 4 illustrates a schematic side view of an OE 30, in accordance with at least one embodiment. The OE 30 may have infinite radiuses of curvatures R1 and R3. The central radius R2 of curvature 96 of the OE 30 may be used to control the amount of focal length separation for different portions of light emitted by the light source module 24.

The OE 30 may comprise a first lens 92 and a second lens 94. The OE 30 may comprise a plano-concave first lens 92 and a plano-convex second lens 94. The OE 30 may be a cemented doublet lens made of crown and flint glass.

According to at least one embodiment, the OE 30 may be a doublet. For example, the optical element may be a “reverse” achromat. The “reverse” achromat's parameters may be chosen based on the different peak wavelengths of the light emitted by the light source module 24 and their respective focus ranges.

According to at least one embodiment, the OE 30 may be stationary and may not need to be moved closer or further away from either the objective lens 32 and/or sensor 34.

According to at least one embodiment, the OE 30 may be combined with the objective lens, positioned in front of the sensor 34.

The central radius R2 may be calculated based on the desired separation between focus ranges for the peak wavelength.

According to at least one embodiment, the OE 30 may be designed with no spherical or coma astigmatism to the system for NA<0.15. According to at least one embodiment, the OE 30 may be designed to provide approximately zero power (i.e. an infinite focal length) for wavelengths in the vicinity of nominal (green) wavelength of 530 nm.

The desired extended focus range may be determined by the thickness of the transparent object 22. The characteristics of the OE 30, and the desired extended focus range may determine the difference between the wavelengths of the intensity peaks of the emitted spectra. The difference between the wavelengths of the intensity peaks of the emitted spectra and the desired extended focus range may thus help to determine the characteristics of the OE 30.

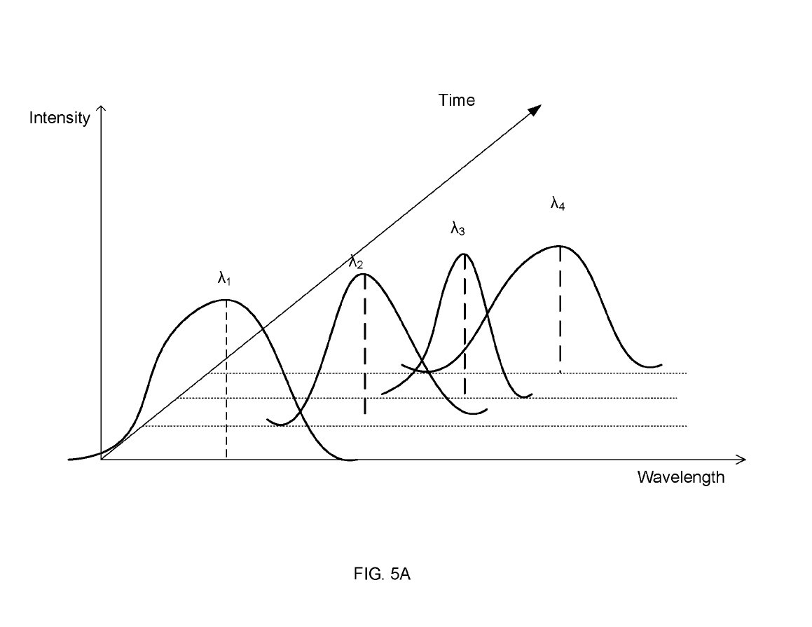

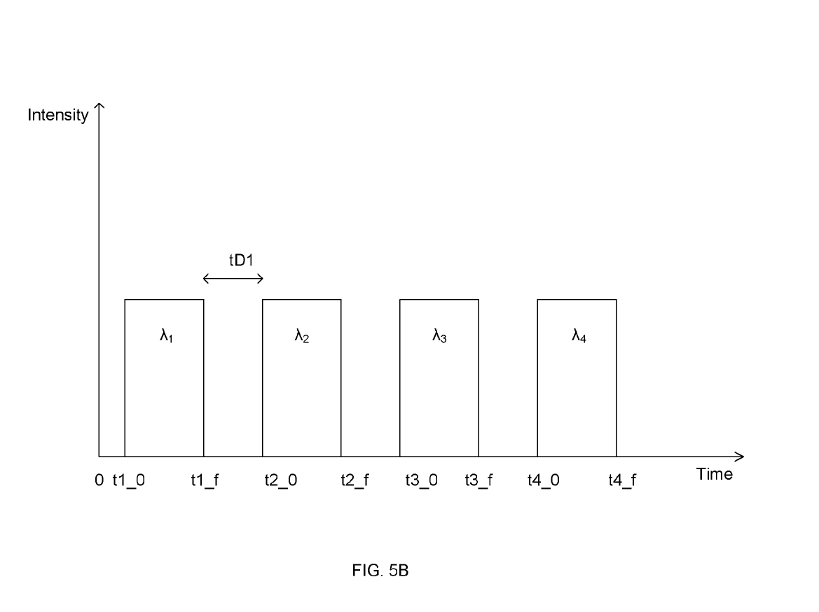

According to at least one embodiment, each portion of light may have a peak of intensity at a certain wavelength. Shown at FIG. 5A is a schematic representation of the spectra emitted by the light source module 24.

The light source module 24 may emit two or more portions of light. For example, a first portion of light may have an intensity peak at a first peak wavelength λ₁, and a second portion of light may have an intensity peak at a second peak wavelength λ₂. A third portion of light may have an intensity peak at a third wavelength λ₃ and a fourth portion having a peak at a fourth wavelength λ₄.

The difference between the adjacent wavelengths of the intensity peaks of portions of light may be between about 20 nm and 50 nm. For example, the first peak wavelength, λ₁, may be about 450 nm. The second peak wavelength λ₂, may be about 475 nm. The third peak wavelength λ₃, may be about 505 nm. The fourth peak wavelength λ₄, may be about 530 nm.

It should be understood that each portion of light may have a different width of the spectral range. It should also be understood that the differences between the adjacent wavelengths of the intensity peaks of portions of light may or may not be equal. For example, (λ₂−λ₁) may or may not be equal to (λ₃−λ₂).

According to at least one embodiment, each portion of light emitted from the light source module 24 may be of a different color. The separation between the intensity peak wavelengths of different portions of light emitted from the light source module 24 may be enough to produce light of different colors. For example, the first portion of light may have peak intensity at a wavelength corresponding to an indigo color; the second portion of light may have peak intensity at a wavelength corresponding to a blue color, etc. When the light source module 24 may emit 4 colors, these 4 colors may be indigo, blue, green, and light green.

Different portions of light with different peak wavelengths emitted by the light source module 24 will be referred to herein as “colors”. It should be understood, however, that the differences between these “colors” may not be apparent to the human eye. However, reference to two or more different “colors” will mean that each color has its own intensity peak wavelength. It should be understood that two colors have two different intensity peak wavelengths.

According to at least one embodiment, each of the light portions emitted by the light source module 24 with different peak wavelengths (or colors) may be time division multiplexed. For example, the light source module 24 may emit N light portions, where N is an integer 2, 3, 4, . . . .

Referring now at FIG. 5B, shown therein is a schematic graphical interpretation of the time dependence of the intensity of each light portion emitted by the light source module 24, in accordance with at least one embodiment. For example, four portions with four different peak wavelengths λ₁, λ₂, λ₃, and λ₄ may be emitted. It should be understood, that the peak intensity of the four portions of light may be different or equal.

According to at least one embodiment, a first light portion with the peak wavelength at the first wavelength λ₁ may be first emitted at time t1_0. At time t1_f, the light source module may stop emitting any light. For example, no light may be emitted from the light emitting module 24 for the duration of the delay period tD1. For example, at t2_0, a light portion with an intensity peak at the second wavelength λ₂ may be emitted. At time t2_f, the light source module may stop emitting any light. At t3_0, a light portion with an intensity peak at the third wavelength may be emitted. At time t3_f, the light source module may stop emitting any light. At t4_0, a light portion with an intensity peak at the fourth wavelength may be emitted. At time t4_f, the light source module may stop emitting any light.

According to at least one embodiment, the light portions with different peak wavelengths may be alternatingly emitted and captured, thereby creating an image that is interlaced with the images captured for each color.

According to at least one embodiment, the light source module 24 may emit light portions alternatingly. For example, the light source module 24 may first emit only the first portion of light having the intensity peak at λ₁ for a first time interval and then may emit only the second portion of light with the intensity peak at λ₂ for the second time interval. The light source module 24 may be adapted to emit more than two portions of light alternatingly, that is, at each particular moment only one portion of light with one peak wavelength may be emitted from the light source module 24.

According to at least one embodiment, focus ranges, corresponding to each color (each light portion emitted from the light source module 24), may be adjacent to each other, so as to define an extended focus range 45 of the system. For example, focus ranges 36, 38, 40, and 42 shown at FIG. 1 may correspond to different colors emitted by the light source module 24. Each color may provide approximately between about 50 mm and about 65 mm of focus range, or between about 55 mm and about 60 mm of focus range.

When the light source module emits 4 colors, and the focus ranges 36, 38, 40, and 42 are adjacent, the extended focus range 45 may be between about 220 mm and about 240 mm.

According to at least one embodiment, the focus ranges corresponding to different portions of light emitted by the light source module 24, may be overlapping.

It should be understood that each focus range corresponds to one color emitted by the light source module 24. It should also be understood that the more the number of colors that the light source module 24 can emit, the more focus ranges may be produced within the inspection sandwich and therefore the larger may be the extended focus range 45. The extended focus range 45 may determine the thickness of the object 22 that may be inspected by the inspection system.

According to at least one embodiment, the sensor 34 may be synchronously triggered with the light source module 24. For example, as the transparent object 22 passes (as shown, for example, at FIG. 10A) within the inspection sandwich formed between the collimating lens system 26 and the collector lens system 28, the light source module 24 may cycle through its various wavelengths. At the same time, the sensor 34 may collect images each time the source 24 has emitted a new portion of light.

Each portion of the transparent object 22 may be exposed to only one portion of light at a time. For example, each portion of the transparent object 22 may be exposed to only one color at a time. This may create an interlaced image in which every Nth line (if the number of portions of light or colors is N) represents an image of the portion of transparent object 22 which has been exposed to only one portion of light with the intensity peak at the Nth wavelength (λ_{N}).

Due to the OE 30, each line in the interlaced image may be in focus at different focal positions within the inspection sandwich (for example, focus ranges 36, 38, 40, or 42 at FIG. 1).

The focal stacking reconstruction algorithm may then de-interlace the N lines of this image in order to obtain N distinct images each of which are focused at a slightly different position within the extended focus range 45, as shown in FIG. 1.

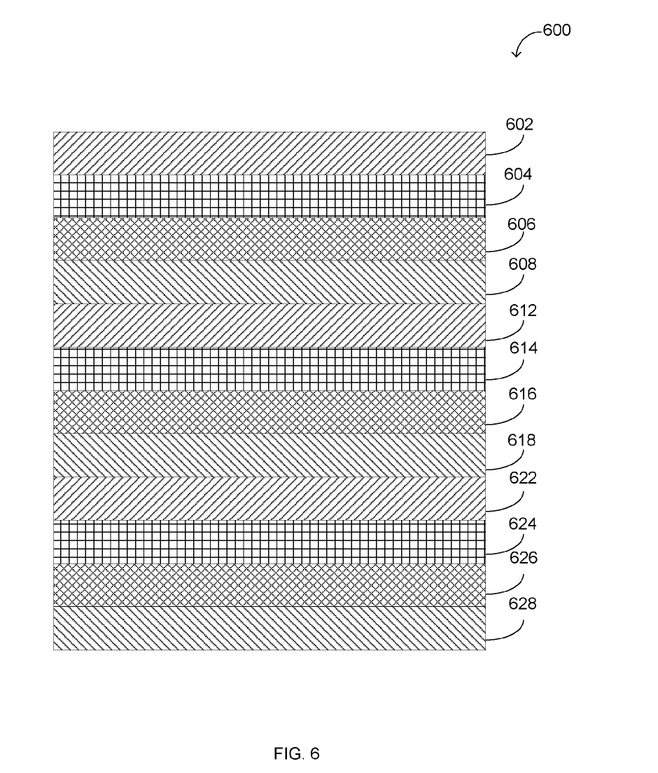

Referring now to FIG. 6, shown therein is a portion 600 of an interlaced image captured by the sensor 34, in accordance with at least one embodiment. In this particular exemplary embodiment, the light source module 24 can emit 4 light portions each of which have an intensity peak wavelength at different wavelengths.

Images 602, 604, 606, and 608 correspond to the images taken of a first portion of the transparent object 22. Images 612, 614, 616, and 618 correspond to the images taken of a second portion of the transparent object 22. Images 622, 624, 626, and 628 correspond to the images taken of a third portion of the transparent object 22. These images may be taken while the transparent object 22 can move in the direction perpendicular or partially perpendicular to the light beams between the collimating lens system 26 and collector lens system 28 sandwich, as shown at FIG. 1.

The portion 602 may correspond to an image taken of a first portion of the transparent object 22 when the first portion of the light with the first peak wavelength has been emitted from the light source module 24. Referring back to FIGS. 1 and 2, this image may correspond to the first focus range 42 at FIG. 1.

The portion 604 may correspond to an image taken of the first portion of the transparent object 22 when the second portion of the light with the second peak wavelength has been emitted from the light source module 24. This image may be in focus because it may correspond to the second focus range 40 at FIG. 1.

The portion 606 may correspond to an image taken of the first portion of the transparent object 22 when the third portion of the light with the third peak wavelength has been emitted from the light source module 24. This image may be in focus because it may correspond to the third focus range 38 at FIG. 1.

The portion 608 may correspond to an image taken of the first portion of the transparent object 22 when the fourth portion of the light with the fourth peak wavelength has been emitted from the light source module 24. This image may be in focus because it may correspond to the fourth focus range 36 at FIG. 1.

The portion 612 may correspond to an image taken of a second portion of the transparent object 22 when the first portion of the light with the first peak wavelength has been emitted from the light source module 24. The portion 614 may correspond to an image taken of the second portion of the transparent object 22 when the second portion of the light with the second peak wavelength has been emitted from the light source module 24. The portion 616 may correspond to an image taken of the second portion of the transparent 22 when the third portion of the light with the third peak wavelength has been emitted from the light source module 24. The portion 618 may correspond to an image taken of the second portion of the transparent object 22 when the fourth portion of the light with the fourth peak wavelength has been emitted from the light source module 24.

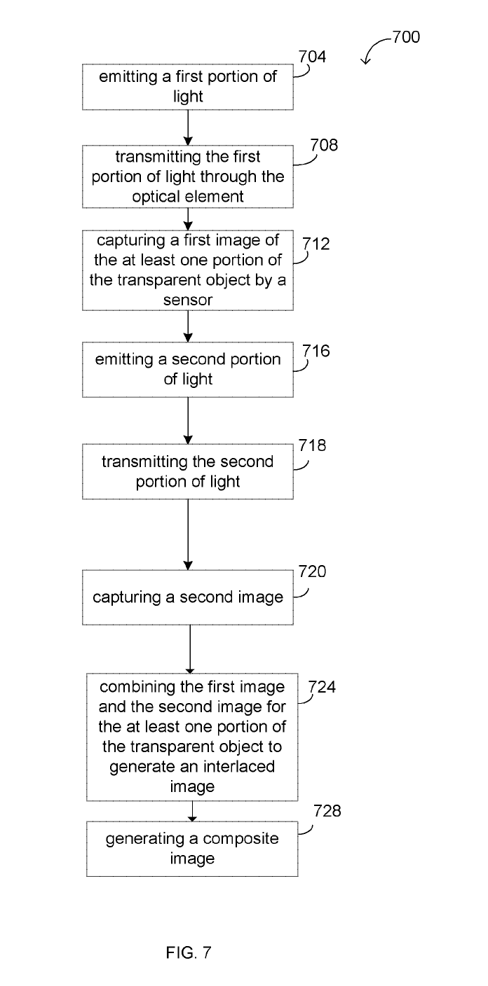

Referring now to FIG. 7, which shows a method 700 of inspecting the transparent object 22, in accordance with at least one embodiment. At step 704, a first portion of light with a first intensity peak may be emitted. The emitted first portion of the light may be condensed by the condenser lens 25 and then collimated by the collimating lens system. As a result, a collimated sheet of light can illuminate at least one portion of transparent object 22. The light transmitted through the object 22 may then be collected by the collector lens system 28.

At step 708, this collected light of the first portion of light may be transmitted through the OE 30. As discussed above, the OE 30 may be adapted to provide a first focus range for the first portion of light. The first focus range for the first portion of light may be the focus range 42, as shown at FIG. 1.

At step 712, a first image of the at least one portion of the object 22 may be captured by a sensor. According to at least one embodiment, the first image may be focused at the first focus range, which may be located at a first focal length from the sensor.

At step 716, a second portion of light with a second intensity peak at a second peak wavelength may be emitted by the light source module 24. According to at least one embodiment, the second portion of light may be emitted after a waiting period after the first portion of light has stopped illuminating.

At step 718, the second portion of light may be transmitted through the at least one portion of the transparent object 22. This second portion of light is then transmitted through the OE 30. As discussed above, the OE 30 may be adapted to provide a second focus range for the second portion of light, wherein the second focus range may be located at a different distance from the sensor compared to the first focus range.

At step 720, a second image of the at least one portion of the transparent object 22 may be captured by the sensor 34.

It should be understood that more than two portions of light may be emitted by the light source module 24 to illuminate one portion of the transparent object 22. As discussed above, the sensor 34 may capture the image for each portion of light.

After the images have been captured by the sensor 34, the first image and the second image for the at least one portion of the object 22 may be combined to generate an interlaced image of the object 22 at step 724. At step 728, a composite image of the object 22 may be generated.

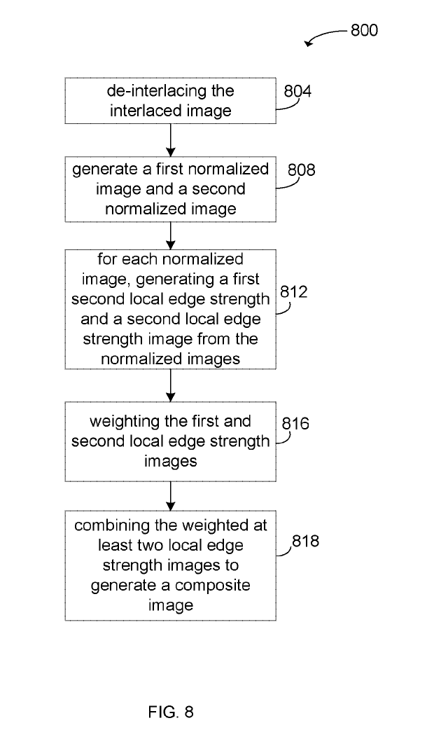

Referring now to FIG. 8, shown therein is a portion 800 of the method 700 of inspecting the transparent object 22, in accordance with at least one embodiment. The method portion 800 may be used to generate the composite image of the transparent object 22. At step 804, the interlaced image may be de-interlaced to generate a first de-interlaced image and a second de-interlaced image.

At step 808, the first de-interlaced image and the second de-interlaced image may be normalized to generate a first normalized image and a second normalized image.

At step 812, for each normalized image, a first second local edge strength and a second local edge strength image may be generated from the normalized images.

At step 816, the first and second local edge strength images may be weighted.

At step 818, the weighted first and second local edge strength images may be combined to generate the composite image of the transparent object 22.

It should be understood that the above steps may be repeated for more than two portions of light with different intensity peak wavelengths emitted by the light source module 24.

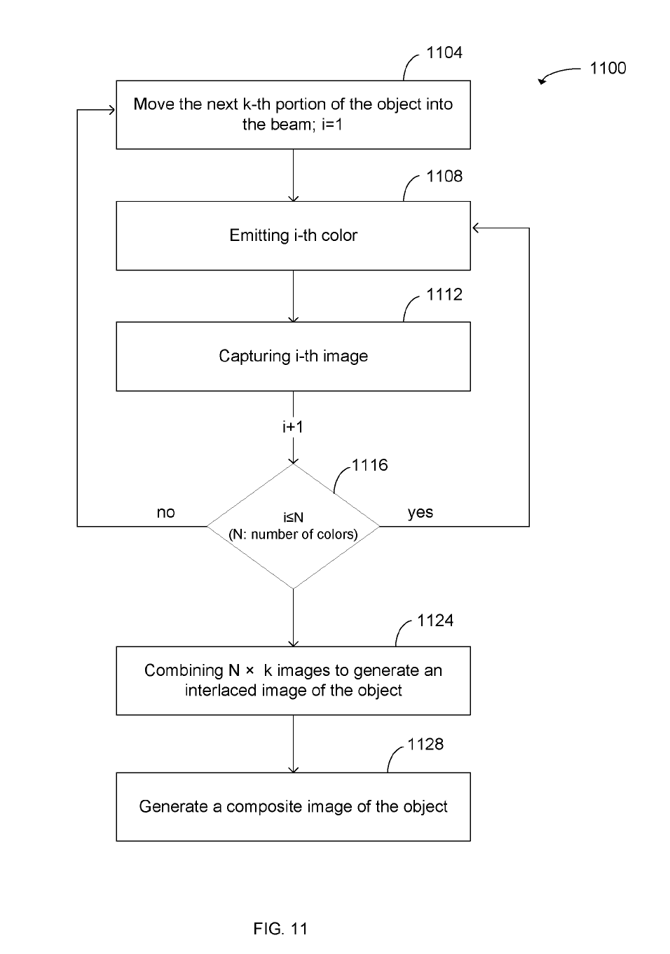

FIG. 11 shows a method of inspection of the transparent object 22 when two or more portions of light have been emitted by the light source module 24, in accordance with at least one embodiment.

At step 1104, shown at FIG. 11, one portion of the transparent object 22 may be moved into the illuminated area. At steps 1108 and 1112, the light with the i-th color (i=1, 2, . . . N) may be emitted and captured. At step 1124, N images for each portion of the transparent object 22 may be combined to generate an interlaced image of the transparent object 22. A composite image 1128 may be generated at step 1128.

For example, the steps described herein may be performed to obtain one interlaced image of the transparent object 22, where the interlaced image may comprise the images for all the portions of the transparent object 22 for N colors.

In another example, the abovementioned steps may be performed separately for each portion of the transparent object 22, where a composite image of each portion of the transparent object 22 is obtained first. In this case, the composite images of each of the portion of the transparent object 22 may be combined later to obtain one composite image of the transparent object 22.

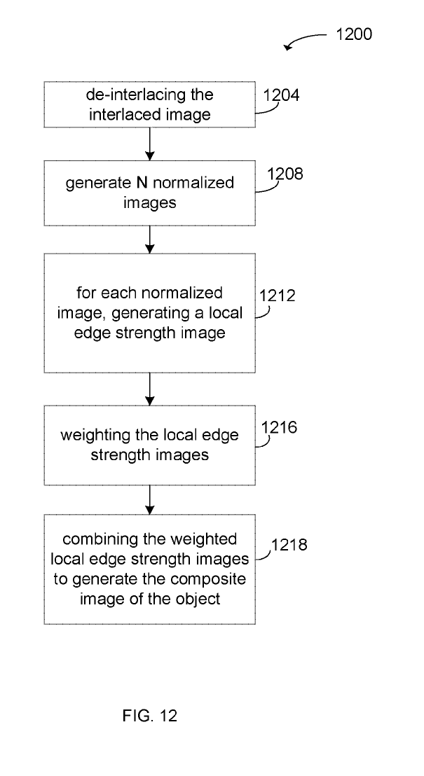

FIG. 12 shows a schematic view method 1200 for generating the composite image of the transparent object 22, in accordance with at least one embodiment. At step 1204, the interlaces image may be de-interlaced. At step 1208, N normalized images may be generated. At step 1212, a local edge strength image may be generated for each normalized image. The local edge strength images may be weighted at step 1216. At step 1218, the weighted local edge strength images may be combined to generate a composite image of the transparent object 22.

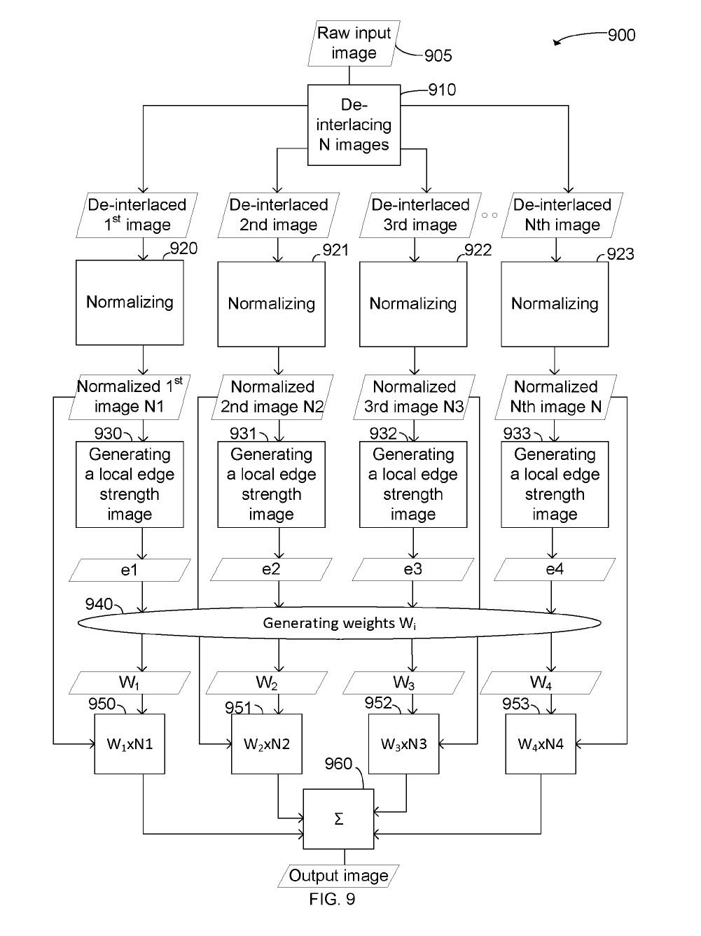

FIG. 9 shows a schematic flow diagram of generating the composite image of the transparent object 22, in accordance with at least one embodiment. A raw input image may comprise an interlaced image as shown at FIG. 6. Each of the portions (e.g., 602, 604, 606, 608) of the input interlaced image 600 maybe in focus at different depths within the inspection sandwich. The method may select those pixels which are most in focus from the input images in order to create a single image which is in focus throughout the inspection sandwich. Except where a defect may be present, all the images present essentially a clear uniform background with almost no dependency on color. The reconstruction algorithm may need to be effective only where defects are present.

The method may seek to reconstruct a focused, normalized image. Post-processing software determines an edge and applies a weighting to the images such that the reconstructed final image of the transparent object 22 under inspection can show a defect in focus. The post-processing may also apply normalization to correct for differences in the sizes of defects.

Referring now to FIG. 9, the method 900 may first de-interlace the raw image into N distinct images at step 910, where N depends on the number of light portions (or colors) emitted by light source module 24. According to at least one embodiment, the sensor 34 (or, for example, the line scan camera) may produce one line of data for each of the light strobe events. Since the light source module 24 cycles through its N different light portions with N different wavelengths in a sequential manner, the output image may consist of interlaced lines, each line originating from a given light portion (color).

At steps 920, 921, 922, 923, the normalization process may remove the light variation across the field of view as well as any variation due to transparency as a function of wavelength. This process may generate normalized images defined as following for the i^{th} image:

$${N}_{i} ( X ) = {c}_{i} [ \frac{max ( {Prof}_{i} ( X ) )}{{Prof}_{i} ( X )} ] {ImageIn}_{i} ( X )$$

$$where$$

$${c}_{i} = \frac{max ( {t}_{1} , {t}_{2} , {t}_{3} , {t}_{4} )}{{t}_{1}} ,$$

Where ImageInᵢ is the input image from the scan line camera during the inspection process for the i^{th} color, Profᵢ is the scan line camera intensity profile with an empty inspection sandwich, X is the pixel index along the horizontal axis, and (t1, t2, t3, t4) are the transmissivities through the transparent object 22 for each of the peak wavelengths of the light portions (colors) emitted by the light source module 24 (assuming the number of light portions is 4).

Each light portion may have a different intensity profile which may not be uniformly distributed across the field of view. According to at least one embodiment, the normalization steps may help to remove this variation. Since the inspection system may be of a transmissive nature and since the transparent object 22 may have slightly different transmissivity for each of the wavelengths passing through it, then it may also be necessary to remove the variations present in the data due to the wavelength dependency on transmissivity.

At steps 930, 931, 932, 933 local edge strength images are generated. These steps of the algorithm can generate local edge strength images from the normalized images Nᵢ. If all the normalized images have the same intensities, the only variations among them may be their relative sharpness. Steps 930, 931, 932, 933 can generate gradient images and map them through function as described in the following equations:

$${G}_{i} = \vert \frac{\partial {N}_{i}}{\partial X} \vert + \vert \frac{\partial {N}_{i}}{\partial Y} \vert$$

$${e}_{i} = exp ( Alpha \times {G}_{i}^{Beta} ) ,$$

where Alpha and Beta are algorithm parameters.

The goal of steps 930, 931, 932, 933 may be to create a focus metric which is bounded between 1 and positive infinity. For example, when the images have little gradient information, the local edge strength may be close to 1. When the gradient information is large, the edge strength may tend to large positive numbers.

At step 940, weights may be generated for each of N colors:

$${w}_{i} = \frac{{e}_{i}}{{e}_{1} + {e}_{2} + {e}_{3} + {e}_{4}} .$$

At steps 950, 951, 952, 953 the normalized images may be multiplied by the weights and then the sum may be calculated at step 960:

OutputImage=w₁×N₁+w₂×N₂+w₃×N₃+w₄×N₄.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

Various apparatuses or processes have been described above to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or processes described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

The various embodiments of the systems and methods described herein may be implemented in hardware or software, or a combination of both. For example, some embodiments may be implemented in computer systems and computer programs, which may be stored on a physical computer readable medium, executable on programmable computers (e.g. computing devices and/or processing devices) each comprising at least one processor, a data storage system (including volatile and non-volatile memory and/or storage elements), at least one input device (e.g. a keyboard, mouse or touchscreen), and at least one output device (e.g. a display screen, a network, or a remote server).

In some embodiments, each program may be implemented in a high level procedural or object oriented programming and/or scripting language to communicate with a computer system. However, the programs can be implemented in assembly or machine language, if desired. In any case, the language may be a compiled or interpreted language.

In some embodiments, the systems and methods as described herein may also be implemented as a non-transitory computer-readable storage medium configured with a computer program, wherein the storage medium so configured causes a computer to operate in a specific and predefined manner to perform at least some of the functions as described herein.

The terms “an embodiment”, “embodiment”, “embodiments”, “the embodiment”, “the embodiments”, “one or more embodiments”, “some embodiments” and “one embodiment” mean “one or more (but not all) embodiments of the present invention(s)” unless expressly specified otherwise.

The terms “including”, “comprising” and variations thereof mean “including but not limited to”, unless expressly specified otherwise. A listing of items does not imply that any or all of the items are mutually exclusive, unless expressly specified otherwise. The terms “a”, “an” and “the” mean “one or more”, unless expressly specified otherwise.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

1. A system for inspecting a transparent object, the system having a plurality of focus ranges and comprising:
a light source module adapted to emit light with a first intensity peak at a first peak wavelength and to emit light with a second intensity peak at a second peak wavelength;
a collimating lens system adapted to transform the emitted light into a collimated sheet of light;
a sensor;
a collector lens system for concentrating the sheet of light, passed through the transparent object, in a plane of the sensor; and
an optical element located between the collector lens system and the sensor, the optical element being adapted to provide
i) a first focus range for the light emitted with the first intensity peak at the first peak wavelength and
ii) a second focus range for the light emitted with the second intensity peak at the second peak wavelength,
iii) wherein at least a portion of the first focus range is located outside of the second focus range.

2. The inspection system of claim 1, wherein the first focus range and the second focus range are adjacent to each other, so as to define an extended focus range of the system.

3. The inspection system of claim 2, wherein the first focus range and the second focus range are overlapping.

4. The inspection system of claim 1, wherein the light source module comprises
a) at least one first light source adapted to emit light with the first intensity peak at the first peak wavelength and
b) at least one second light source adapted to emit light with the second intensity peak at the second peak wavelength.

5. The inspection system of claim 4, wherein the first light source and the second light source are adapted to emit light alternatingly.

6. The inspection system of claim 1, wherein the sensor is adapted to capture
a) at least one first image when the peak intensity of the emitted light is at the first wavelength; and
b) at least one second image when the peak intensity of the emitted light is at the second wavelength.

7. The inspection system of claim 1, wherein the optical element comprises a first lens and a second lens.

8. The inspection system of claim 7, wherein the optical element comprises a piano-concave first lens and a piano-convex second lens.

9. The inspection system of claim 8, wherein the optical element is a doublet.

10. (canceled)

11. The inspection system of claim 1, wherein the light source module comprises at least two light emitting diodes.

12. The inspection system of claim 11, wherein the light source module comprises an array of light emitting diodes.

13. The inspection system of claim 1, wherein each focus range is about 60 mm.

14. The inspection system of claim 1, wherein the light source module is adapted to emit light with a third intensity peak at a third peak wavelength.

15. The inspection system of claim 14, wherein the light source module is adapted to emit light with a fourth intensity peak at a forth peak wavelength.

16. (canceled)

17. (canceled)

18. The inspection system of claim 1, wherein the transparent object is a curved sheet of glass.

19. A method of inspecting a transparent object, the method comprising:
a) emitting a first portion of light having a first intensity peak at a first peak wavelength;
b) transmitting the first portion of light through at least one portion of the transparent object;
c) transmitting the first portion of light through an optical element, the optical element being adapted to provide a first focus range for the first portion of light;
d) capturing a first image of the at least one portion of the transparent object by a sensor, the first image being focused at the first focus range being located at a first focal length from the sensor;
e) emitting a second portion of light having a second intensity peak at a second peak wavelength;
f) transmitting the second portion of light through the at least one portion of the transparent object;
g) transmitting the second portion of light through the optical element, the optical element being adapted to provide a second focus range for the second portion of light, the second focus range being located at a different distance from the sensor compared to the first focus range;
h) capturing a second image of the at least one portion of the transparent object;
i) combining the first image and the second image for the at least one portion of the transparent object to generate an interlaced image of the transparent object; and
j) generating a composite image of the transparent object.

20. The method of claim 19, wherein generating the composite image of the transparent object further comprises:
a) de-interlacing the interlaced image to generate a first de-interlaced image and a second de-interlaced image;
b) normalizing the first de-interlaced image and the second de-interlaced image to generate a first normalized image and a second normalized image;
c) for each normalized image, generating a first second local edge strength and a second local edge strength image from the normalized images;
d) weighting the first and second local edge strength images; and
e) combining the weighted first and second local edge strength images.

21. (canceled)

22. (canceled)

23. (canceled)

24. A method of inspecting a transparent object, the method comprising:
a) emitting at least two portions of light with different intensity peak wavelengths;
b) transmitting the at least two portions of light alternatingly through at least one portion of the transparent object;
c) transmitting the at least two portions of light through an optical element, the optical element adapted to provide at least two focus ranges, each focus range corresponding to one peak wavelength;
d) capturing at least two images of the at least one portion of the transparent object by a sensor, each image being focused at a focus range and each focus range being located at a different focal length from the sensor;
e) combining the at least two images for the at least one portion of the transparent object to generate an interlaced image of the transparent object; and
f) generating a composite image of the transparent object.

25. The method of claim 24, wherein generating the composite image of the transparent object further comprises:
a) de-interlacing the interlaced image to generate at least two de-interlaced images, the number of de-interlaced images being equal to the number of portions of emitted light;
b) normalizing each of the at least two de-interlaced images to generate at least one normalized image;
c) for each normalized image, generating at least two local edge strength images from the at least two normalized images;
d) weighting each of the at least two local edge strength images; and
e) combining the weighted at least two local edge strength images to generate the composite image of the transparent object.

26. The method of claim 24, wherein the number of portions of light emitted is four.

27. (canceled)

28. (canceled)

29. (canceled)
